(19) United States
(12) Patent Application Publication
(10) Pub. No.: US 2024/0122133 A1
(43) Pub. Date: Apr. 18, 2024

(54) LOW-COST HIGH-EFFICIENCY DRIP IRRIGATION SYSTEM FOR COTTON FIELD AND A USE METHOD THEREOF

(71) Applicants: Institute of Cash Crops, Xinjiang Academy of Agricultural Sciences, Urumqi (CN); Shihezi University, Shihezi (CN)

(72) Inventors: Liwen TIAN, Urumqi (CN); Honghai Luo, Shihezi (CN); Hezhong Dong, Urumqi (CN); Na Zhang, Urumqi (CN); Liantao Liu, Urumqi (CN); Guangping Feng, Urumqi (CN); Zhanbiao Wang, Urumqi (CN); Yanjun Zhang, Urumqi (CN); Xianzhe Hao, Shihezi (CN); Jin Li, Urumqi (CN); Zhi Chen, Shihezi (CN); Nan Zhao, Urumqi (CN); Changwen Liu, Urumqi (CN)

(73) Assignees: Institute of Cash Crops, Xinjiang Academy of Agricultural Sciences, Urumqi (CN); Shihezi University, Shihezi (CN)

(21) Appl. No.: 18/489,032

(22) Filed: Dec. 9, 2023

(30) Foreign Application Priority Data
Oct. 18, 2022 (CN) 202211291350.9

(51) Int. Cl. A01G 25/02; A01C 23/04; A01G 22/50; A01G 25/16

(52) U.S. Cl. CPC A01G 25/02; A01C 23/042; A01G 22/50; A01G 25/165; A01G 25/167

(57) ABSTRACT

Disclosed are a low-cost high-efficiency drip irrigation system for a cotton field and a use method thereof. The drip irrigation system for a cotton field includes a filtering device and a water supply device; wherein the filtering device adopts different types of single filtering devices or combined filtering devices according to different water source types; the water supply device includes multiple stages of main pipes, submain pipes and laterals; the laterals (a drip irrigation tape with labyrinth on one side or a drip irrigation tape inlaid with emitters inside) are laid on the surface of the ground and located below a mulch film. The drip irrigation system adopts the design of large flow (1.5-3.4 L/h), slightly larger pipe diameter (>75 mm), low water pressure (operating pressure of drip irrigation tape being 0.03-0.07 MPa) and suitable drip irrigation uniformity (80%-90%). The water and fertilizer management technology includes the technology of preserving seedlings in soil-moisture-insufficient cotton fields, and is matched with the drip irrigation system.

### TECHNICAL FIELD

The present disclosure relates to the technical field of cotton planting, in particular to a low-cost high-efficiency drip irrigation system for a cotton field suitable for cotton planting and a use method thereof.

### BACKGROUND

The growth of cotton needs abundant heat, suitable moisture, nutrients and fertile soil. Xinjiang is the main cotton producing region in China. Due to the unique natural ecological conditions of abundant sunshine and little rain in Xinjiang, water resources are the biggest obstacle to the development of cotton in this cotton region.

Drip irrigation is a typical representative of modern water-saving facility agriculture with remarkable water-saving and yield-increasing effects, but due to the fact that the input cost is high, especially the drip irrigation facilities commonly used in developed countries usually cost as much as 3,000 yuan/mu, the drip irrigation technology is mainly used in vegetables and horticultural fruits with high added value, and is less reported for large-scale applications in field crops in general.

The drip irrigation technology has been applied in a large scale to cotton in Xinjiang as a field crop, and has achieved good water-saving and yield-increasing effects. However, due to the high investment of existing drip irrigation facilities and the large amount of other agricultural materials such as fertilizers and pesticides, the cotton production cost in Xinjiang is about 17,500 yuan/ton, which is much higher than about 10,500 yuan/ton in other major cotton producing regions in the world, which seriously affects the competitiveness of Xinjiang cotton in the international market. Xinjiang has used mulched drip irrigation technology for many years, and accumulated a lot of experience and lessons. However, it is an indisputable fact that mulched drip irrigation has caused high investment in cotton fields because of the need to install corresponding equipment. Although some experiments and demonstrations have been carried out in order to reduce the input of drip irrigation in production, most of them are sporadic reports, lacking systematicness and completeness. The low-cost high-efficiency drip irrigation technology suitable for cotton planting needs to be improved urgently. Under the premise of ensuring yield increase and stable yield of the existing drip irrigation cotton field, how to reduce the input of drip irrigation facilities and operate efficiently is imperative. Numerous investigations and studies also showed that the drip irrigation system with the design ideas of small flow (emitter discharge being 1.0-1.8 L/h), large pipe diameter (pipe diameter up to 220 mm), high water pressure (operating pressure of drip irrigation tape being ≥10 m (≥0.1 MPa)) and high drip irrigation uniformity (≥90%) widely used domestically and abroad is higher in cost and needs to be broken through and redesigned urgently in order to achieve the goal of reducing costs and increasing efficiency.

Accordingly, there is a need to provide a new low-cost high-efficiency drip irrigation system for a cotton field and a use method thereof to address the above problems.

### SUMMARY

The main object of the present disclosure is to provide a new low-cost high-efficiency drip irrigation system for a cotton field and a use method thereof, aiming at solving the problem of high cost input of the existing mulched drip irrigation technology.

To achieve the above object, the present disclosure provides a low-cost high-efficiency drip irrigation system for a cotton field, including a filtering device and a water supply device;

the filtering device includes one or both of a surface water resource irrigation filtering system and an underground water resource irrigation filtering system to correspond to different water source types;

the water supply device includes a plurality of stages of main pipes, submain pipes and laterals, the filtering device is installed or connected between a head of the irrigation system and the main pipes, and irrigation water resources are delivered to the main pipes by a centrifugal pump or submersible pump, and then enter the submain pipes or laterals from the main pipes, wherein the main pipes, the submain pipes and the laterals form a pipe network; a drain valve is installed at a tail end of the main pipe, and the main pipes are buried below a frozen soil layer or at a depth of less than 80 cm underground; each main pipe correspondingly communicates with a plurality of submain pipes, the submain pipes are laid on the surface of the ground, and a laying length of a single submain pipe is 50-100 m; each submain pipe correspondingly communicates with a plurality of laterals, the laterals are laid on the surface of the ground and located below a mulch film, a laying length of a single drip irrigation tape on a single side should be less than a limit length of the theoretical design of the irrigation system, and is usually 40-60 m, the lateral is a drip irrigation tape with labyrinth on one side or a drip irrigation tape inlaid with emitters inside, an emitter spacing is 200-300 mm, and emitters of the laterals face upward; wherein an emitter channel of the drip irrigation tape inlaid with emitters inside is in a sawtooth shape or S shape or a derived shape thereof, and an emitter discharge of the drip irrigation tape inlaid with emitters inside is 1.5-3.5 L/h; an emitter discharge of the drip irrigation tape with labyrinth on one side is 2.0-3.4 L/h; an operating pressure of the drip irrigation tape with labyrinth on one side is 3-7 m which may be converted into 0.03-0.07 MPa.

Optionally, when surface water resources are used for irrigation, the surface water resource irrigation filtering system includes a pre-pumping filtering device and a post-pumping filtering device, wherein the pre-pumping filtering device includes a sediment tank for filtering and a pressureless self-cleaning screen filter with a filtering accuracy of greater than or equal to 100 mesh, and the matched post-pumping filtering device can be selected according to water purification treatment requirements and specifically includes any one or a combination of a screen filter and a disc filter; when underground water resources are used for irrigation, the underground water resource irrigation filtering system does not include a pre-pumping filtering device, but needs to include a post-pumping filtering device, the post-pumping filtering device may be any one of the following 4 combination devices, which are sand filter+screen filter, sand filter+disc filter, centrifugal filter+screen filter and centrifugal filter+disc filter, respectively, or the screen filter or disc filter may be used alone, and filtering precision parameters of the screen filter and the disc filter are both ≥120 mesh.

Optionally, the main pipe is a PVC pipe with a pipe diameter greater than a pipe diameter of the submain pipe; the submain pipe is a PE hose with a bearing pressure of 0.25 Mpa, and the pipe diameter of the submain pipe is one of 75 mm, 90 mm, 110 mm and 125 mm.

Optionally, when a planting pattern of alternating wide rows and narrow rows is adopted in the cotton field s, the laterals are in a two-row-one-belt laying pattern, and the laterals are laid in the middle or one side of the narrow row, wherein the distance from the nearest planting row is 5-7 cm; when the cotton field adopts a planting pattern of equal row spacing of 76 cm, the laterals are in a one-row-one-belt laying pattern, and the distance of the laterals from a target planting row for water supply is 5-7 cm.

Optionally, the lateral is a single-year disposable drip irrigation tape, and the submain pipe is a PE pipe with a service life of 2-3 years.

The present disclosure also provides a use method of the drip irrigation system for a cotton field according to any of the above, including:
drip irrigation: carrying out drip irrigation by means of rotational irrigation via grouped submain pipes, wherein,
drip irrigation is started after sowing and seedling emergence, a total of 7-12 times of water dripping is carried out during the growth period, an irrigation cycle each time is 5-9 d, an irrigation water quota for each drip irrigation is 25-35 m³/mu before August 20, an irrigation water quota for each drip irrigation is 20-25 m³/mu after August 20, and a drip irrigation uniformity is controlled at 80-90%;
drip fertigation: injecting water-soluble fertilizer or liquid fertilizer into a fertilization system through a controlled fertilizer-application dedicated system installed in front of the post-pumping filtering device of the filtering system, and delivering an aqueous solution in which the fertilizer is dissolved to crop root soil using a pressure pipe network of the drip irrigation system, wherein,
during water dripping in the bud stage, drip application of nitrogen fertilizer dissolved in irrigation water with an application rate of 0.8-1.0 kg/mu is carried out each time, drip application of P₂O₅ fertilizer dissolved in irrigation water is carried out once every once to twice water dripping, and an application rate of the P₂O₅ fertilizer each time is 1.0-1.2 kg/mu;
in the flowering and boll-setting stage, drip application of nitrogen fertilizer dissolved in irrigation water with the application rate of 0.9-1.5 kg/mu is carried out during each drip irrigation before August 5, drip application of nitrogen fertilizer dissolved in irrigation water is carried out once every once to twice water dripping after August 5, and the application rate of nitrogen fertilizer each time is 0.6-1.2 kg/mu; in addition, drip application of P₂O₅ fertilizer and K₂O fertilizer dissolved in irrigation water is carried out once to twice depending on growing conditions, morphological characters and target yields of cotton after July 25, and the application rates of P₂O₅ fertilizer and K₂O fertilizer each time are 0.5-1.2 kg/mu, respectively.

Optionally, the use method further includes a step of carrying out drip application of a soil conditioner dissolved in irrigation water once to twice during drip irrigation in a seedling stage and the bud stage when the cotton field is heavy salt-alkali, wherein the soil conditioner is a fully soluble humic acid fertilizer or humic acid soil amendment for improvement of saline-alkali land and improving a utilization rate of fertilizer in saline-alkali land.

Optionally, a water outage time of the use method is generally from late August to early September, but is extended for 5-10 days when a boll opening stage meets a year with high temperature or when the cotton has drought; and drip irrigation is carried out once in early September again.

Optionally, the step of drip irrigation further includes: carrying out drip irrigation once to twice immediately after sowing when the soil of the cotton field cannot meet the emergence requirements due to lack of soil moisture after sowing, with an irrigation cycle of 4-6 days and a water dripping amount of 10-25 m³/mu each time.

According to the above technical solution provided by the present disclosure, how to reduce the input cost of cotton is an urgent technical problem to be solved in cotton production in Xinjiang, and it is ensured that the system operates in the drip irrigation mode with low water pressure of the drip irrigation tapes and large flow of emitters mainly through the improvement and innovation of links such as filtering device selection, water supply device design, lateral laying, irrigation and fertigation.

Wherein, different filtering devices are adopted for different water source types, the drip irrigation water supply device uses a three-stage water supply device of main pipes+submain pipes+laterals. By arranging that the lateral is a disposable use product and the submain pipe is a twice and three-times use product, and the submain pipes and laterals are made of 97-100% recycled PE recycled materials, the water source filtering device only needs to ensure that the lateral are not clogged in the season and can function properly. The lateral drip irrigation tape uses a drip irrigation tape with labyrinth on one side or a drip irrigation tape inlaid with emitters inside, and the channel of the drip irrigation tape inlaid with emitters inside is in a sawtooth shape or S shape or a derived shape thereof. Both the laterals and the submain pipes are laid on the surface of the ground, the emitters of the laterals face upward, laying of the laterals is accomplished by an all-in-one seeding machine with a drip irrigation tape laying function, the manner of rotational irrigation via submain pipes is adopted, a total of 7-12 times of water dripping is carried out during the growth period, and the drip irrigation uniformity is controlled at 80-90%. By water and fertilizer integrated input, irrigation water and fertilizer dissolved in water pass through the main pipes, the submain pipes and the laterals, and slowly, uniformly and quantitatively infiltrate areas of root system development of cotton, thus achieving local irrigation effect in the range of cotton root systems, and finally obtaining high yield and high efficiency of cotton.

In addition, by redesigning key components of existing drip irrigation facilities and equipment, both domestically and abroad, a low cost design of the system is ensured. Therefore, the design idea of large flow (emitter discharge being 2.0-3.4 L/h), low water pressure (operating pressure of drip irrigation tape being 3-7 m, i.e. 0.03-0.07 MPa) and low drip irrigation uniformity (80-90%) is specified, while the conventional design idea of small flow, large pipe diameter, high water pressure and high drip irrigation uniformity commonly are used in drip irrigation facilities elsewhere domestically and abroad. The present disclosure adopts large submain pipes for direct rotational irrigation, thereby reducing input in pipe laying, and realizing reasonable water and fertilizer input and fully integrated operation; the input cost of the redesigned drip irrigation system is only about ⅙ the cost of developed countries, together with scientific operation of water and fertilizer, which both ensures high yield in cotton fields and drastically reduces the production cost. The yield per unit area of the demonstration field is 385-439 kg/mu, the average yield per unit area of the embodiments is increased by 8.5 kg/mu compared with the control, while the average input is reduced by 33.8 yuan/mu, so that the cotton production demand in Xinjiang is met.

### BRIEF DESCRIPTION OF FIGURES

In order to illustrate the technical solutions in the embodiments of the present disclosure or the prior art more clearly, the drawings which are required in the description of the embodiments or the prior art will be briefly introduced below. Obviously, the drawings in the following description are merely some embodiments of the present disclosure, and for a person having ordinary skill in the art, other drawings can also be obtained according to the structures shown in these drawings without making inventive labor.

FIG. 1 is a structural schematic diagram of a drip irrigation system for a cotton field according to an embodiment of the present disclosure.

The objects, functional features and advantages of the present disclosure will be further explained with reference to the accompanying drawings in combination with the embodiments.

### DETAILED DESCRIPTION

The technical solutions in this embodiment will be clearly and completely described below in conjunction with the drawings in this embodiment. Obviously, the described embodiments are only a part of the embodiments of the present disclosure, rather than all of the embodiments. Based on the embodiments in the present disclosure, all other embodiments obtained by a person having ordinary skill in the art without making inventive labor, belong to the scope of protection of the present disclosure.

It should be noted that all directional indications (such as up, down, left, right, front, back, etc.) in this embodiment are only used to explain the relative positional relationship and movement condition between components in a particular attitude (as shown in the figures), and if the particular attitude changes, the directional indications will also change accordingly.

Also, in the description of the present disclosure, “plurality of” means at least two, e.g., two, three, etc., unless expressly and specifically defined otherwise.

As used herein, unless expressly specified and limited otherwise, the terms “connection”, “fixed” and the like are to be construed broadly, e.g., “connection” may be fixed connection or detachable connection or integrated connection; connection may be mechanical connection or electrical connection; connection may be direct connection or indirect connection through an intermediate medium, and may be communication between two elements or represent an interacting relationship between two elements, unless expressly defined otherwise. The specific meaning of the above terms in the present disclosure can be understood by a person having ordinary skill in the art according to specific circumstances.

In addition, the technical solutions between the various embodiments of the present disclosure may be combined with each other, but the combination must be based on the fact that the combination can be implemented by a person having ordinary skill in the art, when the combination of the technical solutions contradicts each other or cannot be implemented, it should be considered that the combination of the technical solutions does not exist and is not within the scope of protection claimed in the present disclosure.

It should be understood that the specific embodiments described herein are merely illustrative of the present disclosure and are not intended to limit the present disclosure.

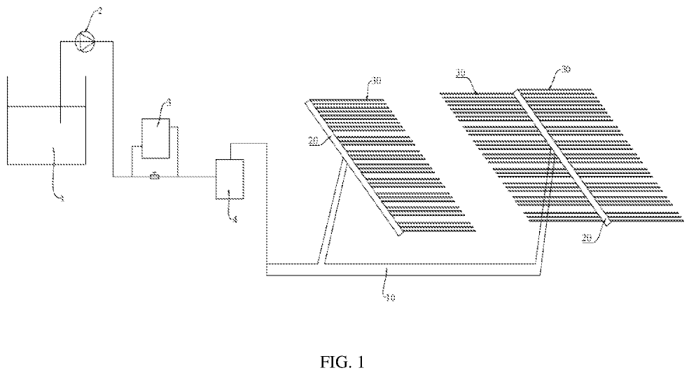

Referring to FIG. 1, the present disclosure provides a drip irrigation system for a cotton field, including a filtering device, a water supply device, and a controlled fertilizer-application dedicated device 3 connected to a main pipe 10 in the water supply device.

The filtering device may include one or both of a surface water filtering device and an underground water filtering device.

Specifically, about the selection of the filtering device, different types of single filtering devices or combined filtering devices may be adopted according to different water source types. When surface water is used for irrigation, a pre-pumping filtering device and a post-pumping filtering device need to be provided, wherein the pre-pumping filtering device is generally composed of a sedimentation tank 1 and a pressureless self-cleaning screen filter, and the post-pumping filtering device 4 may be a screen filter, a disc filter or a combination of a screen filter and a disc filter depending on the water purification treatment requirements. When underground water is used for irrigation, there is no pre-pumping filtering device, and the post-pumping filtering device 4 is set as a combined filtering device of centrifugal filter+screen filter or disc filter.

The water supply device includes multiple stages of main pipes 10, submain pipes 20 and laterals 30, the filtering device is connected between a water source and the main pipes 10, the water source is delivered into an irrigation pipe network (composed of the multiple stages of main pipes, submain pipes and laterals) by a water pump 2 (centrifugal pump or submersible pump), and the controlled fertilizer-application dedicated device 3, the main pipes 10, the submain pipes 20 and the laterals 30 are installed behind the water pump 2 in sequence; the tail end of the main pipe 10 is provided with a drain valve, and the main pipes 10 are buried below the frozen soil layer or underground to a depth below 80 cm; each main pipe 10 correspondingly communicates with a plurality of submain pipes 20, the submain pipes 20 are laid on the surface of the ground, and the laying length of a single submain pipe 20 is 50-100 m; each submain pipe 20 correspondingly communicates with a plurality of laterals 30, the laterals 30 are laid on the surface of the ground and located below the mulch film, and the laying length of a single lateral 30 on one side is 40-60 m.

In a specific example, the main pipe 10 is a PVC pipe, and the pipe diameter of the main pipe 10 is greater than the pipe diameters of the submain pipe 20 and the lateral 30; the submain pipe 20 is a PE hose with a bearing pressure of 0.25 Mpa, and the pipe diameter of the submain pipe 20 is one of 75 mm, 90 mm, 110 mm, and 125 mm.

Optionally, the lateral 30 is a drip irrigation tape with labyrinth on one side or a drip irrigation tape inlaid with emitters inside, the emitter spacing is 200-300 mm, and the emitters of the lateral 30 should be placed upward; wherein the emitter channel of the drip irrigation tape inlaid with emitters inside is in a sawtooth shape or S shape or a derived shape thereof, and the emitter discharge of the drip irrigation tape inlaid with emitters inside is 1.5-2.5 L/h; the emitter discharge of the drip irrigation tape with labyrinth on one side is 2.0-3.4 L/h; the lateral has an operating pressure of 3-7 m (0.03-0.07 MPa), a pipe diameter of 16 mm and a wall thickness of 0.18 mm.

Laying of the laterals 30 can be accomplished by an all-in-one seeding machine with a drip irrigation tape laying function, and under the traction of a tractor, one-stop operation of drip irrigation tape laying, mulch film laying and sowing can be realized.

The lateral 30 may be a single-year disposable drip irrigation tape, and the submain pipe 20 may be a PE pipe with a service life of 2-3 years. Wherein the submain pipe 20 and the lateral 30 used are both made of 97-100% recycled PE recycled materials (waste submain pipes, laterals, greenhouse films, etc.), the lateral 30 is designed as a disposable (one-year) use product, and the submain pipe 20 is a twice and three-times (2-3 years) use product.

When the cotton field adopts a planting pattern of alternating wide rows and narrow rows, the laterals 30 are in a two-row-one-belt laying pattern, the laterals 30 are laid in the middle or one side of the narrow row (the distance from the nearest planting row is 5-7 cm); when the cotton field adopts a planting pattern of equal row spacing of 76 cm, the laterals 30 are in a one-row-one-belt laying pattern, and the distance of the laterals 30 from the target planting row for water supply is 5-7 cm.

The present disclosure also provides a drip irrigation method based on the drip irrigation system for a cotton field of any of the above, including:
drip irrigation: carrying out drip irrigation by means of rotational irrigation via grouped submain pipes, wherein, drip irrigation is started after sowing and seedling emergence, a total of 7-12 times of water dripping is carried out during the growth period with the irrigation cycle being 5-9 days each time, the irrigation water quota is 25-35 m³/mu for each drip irrigation before August 20, the irrigation water quota is 20-25 m³/mu for each drip irrigation after August 20, and the drip irrigation uniformity is controlled at 80-90%. Drip irrigation usually starts from the end of May to the beginning of June after sowing and seedling emergence, and the switching time of drip irrigation water quota may be selected according to the actual cotton growth and weather conditions.

Optionally, the water outage time of the drip irrigation method is generally from late August to early September, and is extended for 5-10 days when the boll opening stage meets a year with high temperature or when the cotton has drought; and drip irrigation is carried out once in early September again. Wherein the water outage time is generally from late August to the beginning of September, and may be extended for another 5-10 days if the boll opening stage meets a year with high temperature or when the cotton has drought, i.e., water dripping is carried out once in early-to-mid-September again.

Optionally, the drip irrigation method further includes a step of carrying out drip application of a soil conditioner dissolved in irrigation water once to twice during drip irrigation in a seedling stage and the bud stage when the cotton field is heavy salt-alkali, wherein the soil conditioner is a fully soluble humic acid fertilizer or humic acid soil amendment for improvement of saline-alkali land and improving the utilization rate of fertilizer in saline-alkali land.

drip fertigation: injecting water-soluble fertilizer or liquid fertilizer into a fertilization system through a controlled fertilizer-application dedicated device installed in front of the post-pumping filtering device 4, and delivering an aqueous solution in which the fertilizer is dissolved to crop root soil using a pressure pipe network (of which the pressure is provided by the water pump) of the drip irrigation system;

wherein, in the bud stage, drip application of nitrogen fertilizer dissolved in irrigation water with the application rate of 0.8-1.0 kg/mu is carried out during each drip irrigation, drip application of phosphorus fertilizer dissolved in irrigation water is carried out once every once to twice drip irrigation, and the application rate of P₂O₅ fertilizer each time is 1.0-1.2 kg/mu; in the flowering and boll-setting stage, drip application nitrogen fertilizer dissolved in irrigation water with the application rate of 0.9-1.5 kg/mu is carried out during each drip irrigation before August 5, drip application of nitrogen fertilizer dissolved in irrigation water is carried out once every once to twice drip irrigation after August 5, and the application rate of nitrogen fertilizer each time is 0.6-1.2 kg/mu; in addition, drip application of phosphorus fertilizer and potassium fertilizer dissolved in irrigation water is carried out once to twice depending on the cotton growing conditions, morphological characters and target yields after July 25, and the application rates of P₂O₅ fertilizer and K₂O fertilizer each time are 0.5-1.2 kg/mu, respectively.

Specifically, fertigation in the growth stage involves injecting water-soluble fertilizer or water-soluble liquid fertilizer which is 100% soluble in water into a controlled fertilizer-application dedicated device, and then delivering an aqueous solution in which the fertilizer is dissolved to crop root soil using the pressure pipe network of the drip irrigation system, so as to realize fertigation. A fertilizer operation method in the bud stage and flowering and boll-setting stage of cotton: the application rate of fertilizer each time should be determined according to the abundance and shortage of soil in cotton fields and the application of base fertilizer. Other management measures are the same as those in conventional drip irrigation cotton fields.

Description will be made below in connection with embodiments of actual irrigation of a specific cotton field:

The following Embodiments 1 and 2 are demonstrated and applied in Cotton Improved Variety Breeding Farm Third Branch in awat county, Xinjiang from 2020 to 2021, with an annual demonstration area of about 1,800 mu. The demonstration site is located in Duolangkuiteman Development Zone, one of the largest cotton planting counties in Xinjiang. The core area of the demonstration site is N40° 43′25″ north latitude and E80° 24′15″ east longitude, which is a typical natural ecological condition in southern Xinjiang cotton region. This implementation site takes surface water as water sources, and the demonstration areas in Embodiments 1 and 2 account for about 60% and 40% of the total demonstration area of the year, respectively.

### Embodiment 1

Step 1: filtering device selection: the filtering device at the head of the drip irrigation system adopts a sedimentation tank, and is equipped with a pre-pumping pressureless self-cleaning screen filter and a post-pumping screen filter;

Step 2: water supply device design: the system adopts a three-stage pipe network water supply device of main pipe+submain pipe+lateral, i.e., the main pipe is directly connected with the submain pipe, and the submain pipe is further directly connected with the lateral; the main pipes are all PVC pipes and are buried below the frozen soil layer, and a drain valve is installed at the tail end of the main pipe; the submain pipe is a PE hose of which the bearing pressure is 25 m (0.25 Mpa); the lateral is a drip irrigation tape which adopts drip irrigation tape with labyrinth on one side, the emitter spacing is 200 mm, the pipe diameters are all 16 mm, the wall thickness is 0.18 mm, the emitter discharge is 2.0 L/h, and the operating pressure of the drip irrigation tape is 3-6 m;

the submain pipe and lateral used are made of 97-100% recycled PE recycled materials (waste submain pipes, laterals, greenhouse films, etc.), wherein the lateral is designed as a disposable (one-year) use product, and the submain pipe is a 3-year use product. The laterals and the submain pipes are both laid on the surface of the ground, wherein the laterals are located below the mulch film, the emitters of the laterals face upward, and the laying length of a single lateral on a single side is 40 m; wherein the diameters of the submain pipes are mostly 75 mm, and the laying length of a single submain pipe is 58 m;

Step 3: lateral laying: by an all-in-one seeding machine with a drip irrigation tape laying function, and under the traction of a tractor, one-stop operation of drip irrigation tape laying, mulch film laying and sowing can be realized. For a cotton field adopting a planting pattern of alternating wide rows and narrow rows, the drip irrigation tapes are in a two-row-one-belt laying pattern, and are laid in the middle or one side of the narrow row; for a cotton field adopting a planting pattern of equal row spacing of 76 cm, the drip irrigation tapes are in a one-row-one-belt laying pattern, and the distance of the drip irrigation tapes from the target planting row for water supply is 5 cm;

Step 4: irrigation: for a drip irrigation cotton field, the manner of rotational irrigation via grouped submain pipes is carried out, and the time and number of times of rotational irrigation are as follows: drip irrigation is started on May 27 after sowing and seedling emergence, with an irrigation cycle of 5-8 days, 11 times of drip irrigation is carried out during the growth period of cotton, the drip irrigation water quota is 25-35 m³/mu each time before August 20, the drip irrigation water quota is 20-25 m³/mu each time after August 20, the drip irrigation uniformity is controlled at 85%, and the water outage time is August 28.

Step 5: fertigation:

for fertigation during the growth period, water-soluble fertilizer or water-soluble liquid fertilizer which is 100% dissolved in water is injected into a controlled fertilizer-application dedicated device, and then an aqueous solution in which the fertilizer is dissolved is delivered to crop root soil using a pressure pipe network (of which the pressure is provided by the water pump) of the drip irrigation system, thereby realizing fertigation.

Bud stage: drip application of nitrogen fertilizer dissolved in irrigation water is carried out during each water dripping, and the application rate of nitrogen fertilizer each time is 0.8-1.0 kg/mu; drip application of phosphorus fertilizer dissolved in irrigation water is carried out once every once to twice water dripping, and the application rate of phosphorus fertilizer each time is 1.0-1.2 kg/mu. Wherein drip application of the soil conditioner dissolved in irrigation water for improvement of saline-alkali land is carried out once when about 150 mu of a heavy saline-alkali cotton field is subjected to drip irrigation in the seedling stage;

flowering and boll-setting stage: drip application of nitrogen fertilizer dissolved in irrigation water with the application rate of 0.9-1.5 kg/mu is carried out during each drip irrigation before August 5, drip application of nitrogen fertilizer dissolved in irrigation water is carried out once every once to twice drip irrigation after August 5, the application rate of nitrogen fertilizer each time is 0.6-1.2 kg/mu, drip application of phosphorus fertilizer and potassium fertilizer dissolved in irrigation water is carried out once after July 25, and the application rates of P₂O₅ fertilizer and K₂O fertilizer each time are 0.5-1.2 kg/mu, respectively.

Step 6: Other management measures are the same as those in conventional drip irrigation cotton fields.

### Embodiment 2

Step 1: filtering device selection: the filtering device at the head of the drip irrigation system adopts a sedimentation tank, and is equipped with a pre-pumping pressureless self-cleaning screen filter and a disc filter.

Step 2: water supply device design: the system adopts a three-stage pipe network water supply device of main pipe+submain pipe+lateral, i.e., the main pipe is directly connected with the submain pipe, and the submain pipe is further directly connected with the lateral; the main pipes are all PVC pipes and are buried 100 cm underground, and a drain valve is installed at the tail end of the main pipe; the submain pipe is a PE hose of which the bearing pressure is 25 m (0.25 Mpa); the lateral is a drip irrigation tape which adopts a drip irrigation tape inlaid with emitters inside, the emitter spacing is 300 mm, the pipe diameters are all 16 mm, the wall thickness is 0.18 mm, the emitter discharge is 2.5 L/h, and the operating pressure of the drip irrigation tape is 4-7 m.

the submain pipe and lateral used are made of 97-100% recycled PE recycled materials (waste submain pipes, laterals, greenhouse films, etc.), wherein the lateral is designed as a disposable (one-year) use product, and the submain pipe is a 2-year use product. The laterals and the submain pipes are both laid on the surface of the ground, wherein the laterals are located below the mulch film, the emitters of the laterals face upward, and the laying length of a single lateral on a single side is 60 m; wherein the diameters of the submain pipes are mostly 90 mm, and the laying length of a single submain pipe is 70 m.

Steps 3-6 are all the same as Steps 3-6 in Embodiment 1.

The following Embodiments 3 and 4 are carried out in the demonstration field of new cotton drip irrigation technology of Xinjiang Academy of Agricultural Sciences in the southwest of Dongmaidi Village, Baojiadian Town, Manas County, Changji Prefecture, Xinjiang from 2020 to 2021, with an annual demonstration area of about 1,260 mu. The core area of the demonstration site is E86° 22′50.05″ east longitude and N44° 17′54.28″ north latitude, which is a typical natural ecological condition of northern Xinjiang cotton region. The implementation site takes underground water as water sources, and the demonstration areas in Embodiments 3 and 4 account for about 30% and 70% of the total demonstration area of the year, respectively.

### Embodiment 3: Filtering Device 4 (FIG. 1)

Step 1: filtering device selection: the filtering device at the head of the drip irrigation system adopts a post-pumping filtering device 4 (FIG. 1), i.e., post-pumping centrifugal filter+screen filter, and is not equipped with any pre-pumping filtering device;

Step 2: water supply device design: the system adopts a three-stage pipe network water supply device of main pipe+submain pipe+lateral, i.e., the main pipe is directly connected with the submain pipe, and the submain pipe is further directly connected with the lateral; the main pipes are all PVC pipes and are buried 80 cm underground, and a drain valve is installed at the tail end of the main pipe; the submain pipe is a PE hose of which the bearing pressure is 25 m (0.25 Mpa); the lateral is a drip irrigation tape which adopts a drip irrigation tape with labyrinth on one side, the emitter spacing is 240 mm, the pipe diameters are all 16 mm, the wall thickness is 0.18 mm, the emitter discharge is 3.4 L/h, and the operating pressure of the drip irrigation tape is 3-6 m;

the submain pipe and lateral used are made of 97-100% recycled PE recycled materials (waste submain pipes, laterals, greenhouse films, etc.), wherein the lateral is designed as a disposable (one-year) use product, and the submain pipe is a 3-year use product. The laterals and the submain pipes are both laid on the surface of the ground, wherein the laterals are located below the mulch film, the emitters of the laterals face upward, and the laying length of a single lateral on a single side is 50 m; wherein the diameter of the submain pipe is 125 mm, and the laying length of a single submain pipe is 100 m.

Step 3: lateral laying: by an all-in-one seeding machine with a drip irrigation tape laying function, and under the traction of a tractor, one-stop operation of drip irrigation tape laying, mulch film laying and sowing can be realized. For a cotton field adopting a planting pattern of alternating wide rows and narrow rows, the drip irrigation tapes are in a two-row-one-belt laying pattern, and are laid in the middle or one side of the narrow row; for a cotton field adopting a planting pattern of equal row spacing of 76 cm, the drip irrigation tapes are in a one-row-one-belt laying pattern, and the distance of the drip irrigation tapes from the target planting row for water supply is 7 cm;

Step 4: irrigation: for a drip irrigation cotton field, the manner of rotational irrigation via submain pipes is carried out, and the time and number of times of rotational irrigation are as follows: after sowing, the soil moisture in cotton fields cannot meet the requirements of seedling emergence, water dripping is carried out once after sowing, and the water dripping amount is 25 m³/mu. After seedling emergence, drip irrigation is started on May 26, with an irrigation cycle of 5-7 days, 12 times of water dripping is carried out during the growth period of cotton, the drip irrigation water quota is 25-35 m³/mu each time before August 20, the drip irrigation water quota is 20-25 m³/mu each time after August 20, the drip irrigation uniformity is controlled at 80-90%, and the water outage time is August 23.

Step 5: fertigation:

for fertigation during the growth period, water-soluble fertilizer or water-soluble liquid fertilizer which is 100% dissolved in water is injected into a controlled fertilizer-application dedicated device, and then an aqueous solution in which the fertilizer is dissolved is delivered to crop root soil using a pressure pipe network (of which the pressure is provided by the water pump) of the drip irrigation system, thereby realizing fertigation.

Wherein in the bud stage, drip application of nitrogen fertilizer dissolved in irrigation water is carried out generally during each water dripping, and the application rate of nitrogen fertilizer each time is 0.8-1.0 kg/mu; drip application of phosphorus fertilizer dissolved in irrigation water is carried out once during each water dripping, and the application rate of phosphorus fertilizer each time is 1.0-1.2 kg/mu. Wherein drip application of the soil conditioner dissolved in irrigation water is carried out once when a heavy saline-alkali cotton field is subjected to drip irrigation in the seedling stage;

wherein in the flowering and boll-setting stage, drip application of nitrogen fertilizer dissolved in irrigation water with the application rate of 0.9-1.5 kg/mu is carried out during each drip irrigation before August 5, drip application of nitrogen fertilizer dissolved in irrigation water is carried out once during each drip irrigation after August 5, the application rate of nitrogen fertilizer each time is 0.6-1.2 kg/mu, drip application of P₂O₅ fertilizer and K₂O fertilizer dissolved in irrigation water is carried out twice after July 25, and the application rates of P₂O₅ fertilizer and K₂O fertilizer each time are 0.5-1.2 kg/mu, respectively.

Step 6: Other management measures are the same as those in conventional drip irrigation cotton fields.

### Embodiment 4

Step 1: filtering device selection: the filtering device at the head of the drip irrigation system adopts a post-pumping filtering device 4 (FIG. 1), i.e., post-pumping centrifugal filter+disc filter, and is not equipped with any pre-pumping filtering device;

Step 2: water supply device design: the system adopts a three-stage pipe network water supply device of main pipe+submain pipe+lateral, i.e., the main pipe is directly connected with the submain pipe, and the submain pipe is further directly connected with the lateral; the main pipes are all PVC pipes and are buried 90 cm underground, and a drain valve is installed at the tail end of the main pipe; the submain pipe is a PE hose of which the bearing pressure is 25 m; the lateral is a drip irrigation tape inlaid with emitters inside, the emitter spacing is 250 mm, the pipe diameters are all 16 mm, the wall thickness is 0.18 mm, the emitter channel is in a derived shape of S, the emitter discharge is 1.5 L/h, and the operating pressure of the drip irrigation tape is 4-7 m;

the submain pipe and lateral used are made of 97-100% recycled PE recycled materials (waste submain pipes, laterals, greenhouse films, etc.), wherein the lateral is designed as a disposable (one-year) use product, and the submain pipe is a 3-year use product. The laterals and the submain pipes are both laid on the surface of the ground, wherein the laterals are located below the mulch film, the emitters of the laterals face upward, and the laying length of a single lateral on a single side is 50 m; wherein the diameter of the submain pipe is 75 mm, and the laying length of a single submain pipe is 50 m;

Step 3: lateral laying: by an all-in-one seeding machine with a drip irrigation tape laying function, and under the traction of a tractor, one-stop operation of drip irrigation tape laying, mulch film laying and sowing can be realized. For a cotton field adopting a planting pattern of alternating wide rows and narrow rows, the drip irrigation tapes are in a two-row-one-belt laying pattern, and are laid in the middle or one side of the narrow row; for a cotton field adopting a planting pattern of equal row spacing of 76 cm, the drip irrigation tapes are in a one-row-one-belt laying pattern, and the distance of the drip irrigation tapes from the target planting row for water supply is 6 cm;

Step 4: irrigation: for a drip irrigation cotton field, the manner of rotational irrigation via submain pipes is carried out, and the time and number of times of rotational irrigation are as follows: after sowing, the soil moisture in cotton fields cannot meet the requirements of seedling emergence, water dripping is carried out twice after sowing, and the water dripping amount each time is 10-15 m³/mu. After seedling emergence, drip irrigation is started on May 26, with an irrigation cycle of 7-9 days, 8 times of water dripping is carried out during the growth period of cotton, the drip irrigation water quota is 25-35 m³/mu each time before August 20, the drip irrigation water quota is usually 20-25 m³/mu after August 20, the drip irrigation uniformity is controlled at 80-90%, and the water outage time is September 4.

Step 5: for fertigation during the growth period, water-soluble fertilizer or water-soluble liquid fertilizer which is 100% dissolved in water is injected into a differential pressure fertilization tank (a controlled fertilizer-application dedicated device), and then an aqueous solution in which the fertilizer is dissolved is delivered to crop root soil using a pressure pipe network (of which the pressure is provided by the water pump) of the drip irrigation system, thereby realizing fertigation.

Wherein in the bud stage, drip application of nitrogen fertilizer dissolved in irrigation water is carried out generally during each water dripping, and the application rate of nitrogen fertilizer each time is 0.8-1.0 kg/mu; drip application of phosphorus fertilizer dissolved in irrigation water is carried out once every twice water dripping, and the application rate of phosphorus fertilizer each time is 1.0-1.2 kg/mu. Wherein drip application of the soil conditioner dissolved in irrigation water is carried out once when a heavy saline-alkali cotton field is subjected to drip irrigation in the seedling stage and the bud stage;

wherein in the flowering and boll-setting stage, drip application of nitrogen fertilizer dissolved in irrigation water with the application rate of 0.9-1.5 kg/mu is carried out during each drip irrigation before August 5, drip application of nitrogen fertilizer dissolved in irrigation water is carried out once during each drip irrigation after August 5, the application rate of nitrogen fertilizer each time is 0.6-1.2 kg/mu, drip application of P₂O₅ fertilizer and K₂O fertilizer dissolved in irrigation water is carried out once after July 25, and the application rates of P₂O₅ fertilizer and K₂O fertilizer each time are 0.5-1.2 kg/mu, respectively.

Step 6: Other management measures are the same as those in conventional drip irrigation cotton fields.

Implementation Results:

The embodiments of the present disclosure were subjected to yield determination separately on September 15 to 25 of the year of implementation, and the change of input cost was counted after harvest in that year. The emergence rates were investigated separately taking high-yield cotton fields surrounding the implementation site in that year as a control. During yield determination, 2-3 cotton fields were randomly selected for each embodiment, and 3-4 points were investigated for each cotton field. Finally, the two-year average of each embodiment was the yield per unit area of this embodiment, and the yield per unit area of the surrounding high-yield cotton fields was obtained in the same way. The input change of a cotton field is based on the cotton field subjected to yield determination, and the two-year average of each embodiment was taken as the input change data for this embodiment.

The yield determination results of the four embodiments were that the yields per unit area of seed cotton were 397 kg/mu, 439 kg/mu, 385 kg/mu and 398 kg/mu, respectively, and accordingly the average yield per unit area was 404.8 kg/mu; the results of the control are that the yields per unit area of seed cotton were 405 kg/mu, 402 kg/mu, 391 kg/mu and 387 kg/mu, respectively, and accordingly the average yield per unit area was 396.3 kg/mu, so that the average yield per unit area of the embodiments was increased by 8.5 kg/mu compared with the control. The cotton field inputs of the four embodiments were reduced by 44 yuan/mu, 21 yuan/mu, 52 yuan/mu and 18 yuan/mu, respectively compared with the surrounding cotton field control, and accordingly the average input of the embodiments was reduced by 33.8 yuan/mu. Therefore, the purpose of reducing cost and increasing efficiency is achieved, and the cotton production demand in Xinjiang is met.

The above description is only a preferred embodiment of the present disclosure and is not intended to limit the patent scope of the present disclosure. Any equivalent structure or equivalent process transformation made by using the description and attached drawings of the present disclosure, or directly or indirectly used in other related technical fields, is similarly included in the patent protection scope of the present disclosure.

1. A low-cost high-efficiency drip irrigation system for a cotton field, comprising a filtering device and a water supply device; wherein the filtering device comprises one or both of a surface water resource irrigation filtering system and an underground water resource irrigation filtering system to correspond to different water source types; the water supply device comprises a plurality of stages of main pipes, submain pipes and laterals, the filtering device is installed or connected between a head of the irrigation system and the main pipes, and irrigation water resources are delivered to the main pipes by a centrifugal pump or submersible pump, and then enter the submain pipes or laterals from the main pipes, wherein the main pipes, the submain pipes and the laterals form a pipe network; a drain valve is installed at a tail end of the main pipe that is buried below a frozen soil layer or at a depth of less than 80 cm underground; each main pipe correspondingly communicates with a plurality of submain pipes, the submain pipes are laid on the surface of the ground, and a laying length of a single submain pipe is 50-100 m; each submain pipe correspondingly communicates with a plurality of laterals, the laterals are laid on the surface of the ground and located below a mulch film, a laying length of a single drip irrigation tape on a single side is less than a limit length of the theoretical design of the irrigation system, and is usually 40-60 m, the lateral is a drip irrigation tape with labyrinth on one side or a drip irrigation tape inlaid with emitters inside, an emitter spacing is 200-300 mm, and emitters of the laterals face upward; wherein an emitter channel of the drip irrigation tape inlaid with emitters inside is in a sawtooth shape or S shape or a derived shape of the sawtooth shape or S shape, and an emitter discharge of the drip irrigation tape inlaid with emitters inside is 1.5-2.5 L/h; an emitter discharge of the drip irrigation tape with labyrinth on one side is 2.0-3.4 L/h; an operating pressure of the drip irrigation tape with labyrinth on one side is 0.03-0.07 MPa.

2. The low-cost high-efficiency drip irrigation system for a cotton field according to claim 1, wherein the surface water resource irrigation filtering system comprises a pre-pumping filtering device and a post-pumping filtering device, wherein the pre-pumping filtering device comprises a sediment tank for filtering and a pressureless self-cleaning screen filter with a filtering accuracy of greater than or equal to 100 mesh, and the matched post-pumping filtering device can be selected according to water purification treatment requirements and specifically comprises one or a combination of a screen filter and a disc filter with a filtering accuracy greater than or equal to 120 mesh; the underground water resource irrigation filtering system does not comprise a pre-pumping filtering device but needs to comprise a post-pumping filtering device, the post-pumping filtering device is any one of the following 4 combination devices, which are sand filter+screen filter, sand filter+disc filter, centrifugal filter+screen filter and centrifugal filter+disc filter, respectively, or the screen filter or disc filter is used alone, and filtering precision parameters of the screen filter and the disc filter are both ≥120 mesh.

3. The low-cost high-efficiency drip irrigation system for a cotton field according to claim 1, wherein the main pipe is a PVC pipe with a pipe diameter greater than a pipe diameter of the submain pipe; the submain pipe is a PE hose with a bearing pressure of 0.25 Mpa, and the pipe diameter of the submain pipe is one or a combination of more of 75 mm, 90 mm, 110 mm and 125 mm.

4. The low-cost high-efficiency drip irrigation system for a cotton field according to claim 1, wherein when the cotton field adopts a planting pattern of alternating wide rows and narrow rows, the laterals are in a two-row-one-belt laying pattern, and the laterals are laid in the middle or one side of the narrow row, wherein the distance from the nearest planting row is 5-7 cm; when the cotton field adopts a planting pattern of equal row spacing of 76 cm, the laterals are in a one-row-one-belt laying pattern, and the distance of the laterals from a target planting row for water supply is 5-7 cm.

5. The low-cost high-efficiency drip irrigation system for a cotton field according to claim 1, wherein the lateral is a single-year disposable drip irrigation tape, and the submain pipe is a PE pipe with a service life of 2-3 years.

6. A method of irrigating a cotton field using the low-cost high-efficiency drip irrigation system according to claim 1, comprising:
drip irrigation: carrying out drip irrigation by means of rotational irrigation via grouped submain pipes, wherein,
drip irrigation is started after sowing and seedling emergence, a total of 7-12 times of water dripping is carried out during the growth period, an irrigation cycle each time is 5-9 d, an irrigation water quota for each drip irrigation is 25-35 m³/mu before August 20, an irrigation water quota for each drip irrigation is 20-25 m³/mu after August 20, and a drip irrigation uniformity is controlled at 80-90%;
drip fertigation: injecting water-soluble fertilizer or liquid fertilizer into a fertilization system through a controlled fertilizer-application dedicated system installed in front of the post-pumping filtering device of the filtering system, and delivering an aqueous solution in which the fertilizer is dissolved to crop root soil using a pressure pipe network of the drip irrigation system, wherein,
during water dripping in the bud stage, drip application of nitrogen fertilizer dissolved in irrigation water with an application rate of 0.8-1.0 kg/mu is carried out each time, drip application of P₂O₅ fertilizer dissolved in irrigation water is carried out once every once to twice water dripping, and an application rate of the P₂O₅ fertilizer each time is 1.0-1.2 kg/mu;
in the flowering and boll-setting stage, drip application of nitrogen fertilizer dissolved in irrigation water with the application rate of 0.9-1.5 kg/mu is carried out during each drip irrigation before August 5, drip application of nitrogen fertilizer dissolved in irrigation water is carried out once every once to twice water dripping after August 5, and the application rate of nitrogen fertilizer each time is 0.6-1.2 kg/mu; in addition, drip application of P₂O₅ fertilizer and K₂O fertilizer dissolved in irrigation water is carried out once to twice depending on growing conditions, morphological characters and target yields of cotton after July 25, and the application rates of P₂O₅ fertilizer and K₂O fertilizer each time are 0.5-1.2 kg/mu, respectively.

7. The method according to claim 6, further comprising a step of carrying out drip application of a soil conditioner dissolved in irrigation water once to twice during drip irrigation in a seedling stage and the bud stage when the cotton field is heavy salt-alkali, wherein the soil conditioner is a fully soluble humic acid fertilizer or humic acid soil amendment for improvement of saline-alkali land and improving a utilization rate of fertilizer in saline-alkali land.

8. The method according to claim 7, wherein a water outage time of the use method is generally from late August to early September, but is extended for 5-10 days when a boll opening stage meets a year with high temperature or when the cotton has drought; and drip irrigation is carried out once in early September again.

9. The method according to claim 7, wherein the step of drip irrigation further comprises: carrying out drip irrigation once to twice immediately after sowing when the soil of the cotton field cannot meet the emergence requirements due to lack of soil moisture after sowing, with an irrigation cycle of 4-6 days and a water dripping amount of 10-25 m³/mu each time.

10. A method of irrigating-a cotton field using the low-cost high-efficiency drip irrigation system according to claim 2, comprising:
drip irrigation: carrying out drip irrigation by means of rotational irrigation via grouped submain pipes, wherein,
drip irrigation is started after sowing and seedling emergence, a total of 7-12 times of water dripping is carried out during the growth period, an irrigation cycle each time is 5-9 d, an irrigation water quota for each drip irrigation is 25-35 m³/mu before August 20, an irrigation water quota for each drip irrigation is 20-25 m³/mu after August 20, and a drip irrigation uniformity is controlled at 80-90%;
drip fertigation: injecting water-soluble fertilizer or liquid fertilizer into a fertilization system through a controlled fertilizer-application dedicated system installed in front of the post-pumping filtering device of the filtering system, and delivering an aqueous solution in which the fertilizer is dissolved to crop root soil using a pressure pipe network of the drip irrigation system, wherein,
during water dripping in the bud stage, drip application of nitrogen fertilizer dissolved in irrigation water with an application rate of 0.8-1.0 kg/mu is carried out each time, drip application of P₂O₅ fertilizer dissolved in irrigation water is carried out once every once to twice water dripping, and an application rate of the P₂O₅ fertilizer each time is 1.0-1.2 kg/mu;
in the flowering and boll-setting stage, drip application of nitrogen fertilizer dissolved in irrigation water with the application rate of 0.9-1.5 kg/mu is carried out during each drip irrigation before August 5, drip application of nitrogen fertilizer dissolved in irrigation water is carried out once every once to twice water dripping after August 5, and the application rate of nitrogen fertilizer each time is 0.6-1.2 kg/mu; in addition, drip application of P₂O₅ fertilizer and K₂O fertilizer dissolved in irrigation water is carried out once to twice depending on growing conditions, morphological characters and target yields of cotton after July 25, and the application rates of P₂O₅ fertilizer and K₂O fertilizer each time are 0.5-1.2 kg/mu, respectively.

11. The method according to claim 10, further comprising a step of carrying out drip application of a soil conditioner dissolved in irrigation water once to twice during drip irrigation in a seedling stage and the bud stage when the cotton field is heavy salt-alkali, wherein the soil conditioner is a fully soluble humic acid fertilizer or humic acid soil amendment for improvement of saline-alkali land and improving a utilization rate of fertilizer in saline-alkali land.

12. The method according to claim 11, wherein a water outage time of the use method is generally from late August to early September, but is extended for 5-10 days when a boll opening stage meets a year with high temperature or when the cotton has drought; and drip irrigation is carried out once in early September again.

13. The method according to claim 11, wherein the step of drip irrigation further comprises: carrying out drip irrigation once to twice immediately after sowing when the soil of the cotton field cannot meet the emergence requirements due to lack of soil moisture after sowing, with an irrigation cycle of 4-6 days and a water dripping amount of 10-25 m³/mu each time.

14. A method of irrigating-a cotton field using the low-cost high-efficiency drip irrigation system according to claim 3, comprising:
drip irrigation: carrying out drip irrigation by means of rotational irrigation via grouped submain pipes, wherein,
drip irrigation is started after sowing and seedling emergence, a total of 7-12 times of water dripping is carried out during the growth period, an irrigation cycle each time is 5-9 d, an irrigation water quota for each drip irrigation is 25-35 m³/mu before August 20, an irrigation water quota for each drip irrigation is 20-25 m³/mu after August 20, and a drip irrigation uniformity is controlled at 80-90%;
drip fertigation: injecting water-soluble fertilizer or liquid fertilizer into a fertilization system through a controlled fertilizer-application dedicated system installed in front of the post-pumping filtering device of the filtering system, and delivering an aqueous solution in which the fertilizer is dissolved to crop root soil using a pressure pipe network of the drip irrigation system, wherein,
during water dripping in the bud stage, drip application of nitrogen fertilizer dissolved in irrigation water with an application rate of 0.8-1.0 kg/mu is carried out each time, drip application of P₂O₅ fertilizer dissolved in irrigation water is carried out once every once to twice water dripping, and an application rate of the P₂O₅ fertilizer each time is 1.0-1.2 kg/mu;
in the flowering and boll-setting stage, drip application of nitrogen fertilizer dissolved in irrigation water with the application rate of 0.9-1.5 kg/mu is carried out during each drip irrigation before August 5, drip application of nitrogen fertilizer dissolved in irrigation water is carried out once every once to twice water dripping after August 5, and the application rate of nitrogen fertilizer each time is 0.6-1.2 kg/mu; in addition, drip application of P₂O₅ fertilizer and K₂O fertilizer dissolved in irrigation water is carried out once to twice depending on growing conditions, morphological characters and target yields of cotton after July 25, and the application rates of P₂O₅ fertilizer and K₂O fertilizer each time are 0.5-1.2 kg/mu, respectively.

15. The method according to claim 14, further comprising a step of carrying out drip application of a soil conditioner dissolved in irrigation water once to twice during drip irrigation in a seedling stage and the bud stage when the cotton field is heavy salt-alkali, wherein the soil conditioner is a fully soluble humic acid fertilizer or humic acid soil amendment for improvement of saline-alkali land and improving a utilization rate of fertilizer in saline-alkali land.

16. The method according to claim 14, wherein a water outage time of the use method is generally from late August to early September, but is extended for 5-10 days when a boll opening stage meets a year with high temperature or when the cotton has drought; and drip irrigation is carried out once in early September again.

17. The method according to claim 14, wherein the step of drip irrigation further comprises: carrying out drip irrigation once to twice immediately after sowing when the soil of the cotton field cannot meet the emergence requirements due to lack of soil moisture after sowing, with an irrigation cycle of 4-6 days and a water dripping amount of 10-25 m³/mu each time.
